(19) United States
(12) Patent Application Publication
(10) Pub. No.: US 2018/0242773 A1
(43) Pub. Date: Aug. 30, 2018

(54) ANTI-OVERFLOW CONTROL METHOD FOR CONTROLLING A FOOD PROCESSOR AND THE FOOD PROCESSOR THEREOF

(71) Applicants: GUANGDONG MIDEA CONSUMER ELECTRIC MANUFACTURING CO., LTD., Foshan (CN); MIDEA GROUP CO., LTD., Foshan (CN)

(72) Inventors: Sanying Yu, Foshan (CN); Kunren Yin, Foshan (CN); Yan Tang, Foshan (CN)

(21) Appl. No.: 15/968,667

(22) Filed: May 1, 2018

Related U.S. Application Data
(63) Continuation of application No. PCT/CN2017/091497, filed on Jul. 3, 2017.

(30) Foreign Application Priority Data
Jul. 27, 2016 (CN) 201610605755.3
Jul. 27, 2016 (CN) 201620806260.2

(51) Int. Cl. A47J 27/62; A47J 43/07

(52) U.S. Cl. CPC A47J 27/62; A23C 11/10; A47J 43/07

(57) ABSTRACT

A method for controlling the food processor is disclosed. When the food processor is powered on, it is determined. whether the food processor generates an initiation instruction for detecting a boiling point based on external actions during a preset time period. If so, a pre-stored process is started for detecting the boiling point, to obtain a current boiling point of water inside the food processor at a current location; and the food processor is controlled to heat water inside the food processor accordingly. If not, the food processor is controlled to heat water inside the food processor based on a pre-stored boiling point in the food processor. With detecting the current boiling point after the specific initiation instruction for detecting the boiling point is detected, the food processor can avoid misjudging the boiling point to avoid the overflow of the mixture of water and food in the food processor.

### RELATED APPLICATIONS

This application is a continuation application of PCT Patent Application No. PCT/CN2017/091497, entitled “ANTI-OVERFLOW CONTROL METHOD FOR CONTROLLING A FOOD PROCESSOR AND THE FOOD PROCESSOR THEREOF” filed on Jul. 3, 2017, which claims priority to: (i) Chinese Patent Application No. 201620806260.2, filed with the Chinese Patent Office on Jul. 27, 2016, and entitled “FOOD PROCESSOR” and (ii) Chinese Patent Application No. 201610605755.3, filed with the Chinese Patent Office on Jul. 27, 2016, and entitled “ANTI-OVERFLOW CONTROL METHOD FOR CONTROLLING A FOOD PROCESSOR AND THE FOOD PROCESSOR THEREOF”, all of which are incorporated herein by reference in their entirety.

### TECHNICAL FIELD

The present disclosure relates to a field of cooking appliances, and in particular to an anti-overflow control method for controlling a food processor and the food processor thereof.

### BACKGROUND

With the development of science and technology, the food processor, especially the liquid heating food processor obtains comprehensive application. For the conventional food processors, judging whether the water is boiling is usually determined according to the normal altitude. When the food processor is used in high altitude regions such as a plateau area, a low pressure makes the boiling point decrease, the boiling point is likely misjudged by the food processor that keeps heating accordingly, resulting in the overflow of the mixture of water and food in the food processor.

### SUMMARY

The present disclosure relates to an anti-overflow control method for controlling a food processor and the food processor thereof, aims to solve a problem that a boiling point misjudged by the food processor results in an overflow of a mixture of water and food in the food processor.

To realize the above aims, the present disclosure relates to an anti-overflow control method for controlling a food processor, including:

when the food processor is powered on, judging whether the food processor generates an initiation instruction for detecting the boiling point based on external actions during a preset time period;

if the food processor generates the initiation instruction for detecting the boiling point based on external actions during the preset time period, starting a pre-stored process for detecting the boiling point, to obtain a current boiling point of water inside the food processor at a current location;

controlling the food processor to heat water inside the food processor based on the current boiling point of the water; and

if the food processor fails to generate the initiation instruction for detecting the boiling point based on external actions during the preset time period, controlling the food processor to heat water inside the food processor based on a pre-stored boiling point in the food processor.

Preferably, when the food processor is provided with a specialized button for starting a process of detecting the boiling point, after the specialized button is triggered, controlling the food processor to generate the initiation instruction for detecting a boiling point.

When the food processor is only provided with normal functional buttons, after the normal functional buttons as combined are triggered or a single functional button is long-pressed, controlling the food processor to generate the initiation instruction for detecting the boiling point.

When a wireless connection is used between the food processor and a corresponding mobile terminal, after a trigger instruction sent by the mobile terminal is detected, controlling the food processor to generate the initiation instruction for detecting the boiling point.

Preferably, if the food processor generates the initiation instruction for detecting the boiling point based on external actions during the preset time period, starting the pre-stored process for detecting the boiling point to obtain the boiling point of the water inside the food processor at a current location, including:

if the food processor generates the initiation instruction for detecting the boiling point based on external actions during the preset time period, controlling the food processor to heat the water inside the food processor;

detecting temperature changes of the water inside the food processor, when detecting the temperature of the water inside the food processor is invariable during a preset period, the temperature is obtained as a constant temperature.

In this case, an invariable temperature is regarded as the boiling point of the water inside the food processor at a current location.

Preferably, the boiling point of the water in the food processor at a current location is regarded as the current boiling point of the water.

The step of controlling the food processor to heat water inside the food processor based on the current boiling point, includes:

controlling the food processor to heat the water inside the food processor while detecting variable temperatures of the water inside the food processor;

when detecting the variable temperatures of the water reach the current boiling point of the water, controlling the food processor to stop heating.

Preferably, before the step of when detecting the variable temperatures of the water reach the current boiling point of the water, controlling the food processor to stop heating further includes:

when detecting a difference between the variable temperatures of the water and the current boiling point of the water, controlling the food processor to reduce heating power.

A food processor thereof is further disclosed by the present disclosure, including a main control chip, in which the main control chip includes:

an instruction judging module, being configured for, when the food processor is powered on, judging whether the food processor generates an initiation instruction for detecting a boiling point based on external actions during a preset time period;

a process starting module, being configured for, if the food processor generates the initiation instruction for detecting the boiling point based on external actions during the preset time period, starting the pre-stored process for detecting the boiling point, to obtain the boiling point in the food processor at a current location;

a first heating execution module, being configured for controlling the food processor to heat water inside the food processor based on the boiling point of the water inside the food processor at a current location; and

a second heating execution module, being configured for, if the food processor fails to generate the initiation instruction for detecting the boiling point based on external actions during the preset time period, controlling the food processor to heat the water inside the food processor based on a pre-stored boiling point in the food processor.

Preferably, the main control chip further includes an operation induction module.

When the food processor is provided with a specialized button for starting the process of detecting the boiling point, after the specialized button is triggered, controlling the food processor to generate the initiation instruction for detecting the boiling point.

When the food processor is only provided with the normal functional buttons, after the normal functional buttons as combined are triggered or a single functional button is long-pressed, controlling the food processor to generate the initiation instruction for detecting boiling point.

When a wireless connection is used between the food processor and a corresponding mobile terminal, after a trigger instruction sent by the mobile terminal is detected, controlling the food processor to generate the initiation instruction for detecting the boiling point.

Preferably, the process starting module includes:

a preheating unit, being configured for, when the food processor generates the initiation instruction for detecting the boiling point based on external actions during the preset time period controlling the food processor to heat the water inside the food processor;

a temperature detecting unit, being configured for, detecting temperature changes of the water inside the food processor, when detecting the temperature of the water inside the food processor is invariable during the preset period, the temperature is obtained as a constant temperature;

a boiling point determining unit, being configured for regarding the constant temperature as the boiling point of the water inside the food processor at a current location.

Preferably, the boiling point of the water in the food processor at a current location is regarded as the current boiling point of the water.

The first heating execution module includes:

a heating detect unit, being configured for controlling the food processor to heat the water inside the food processor while detecting variable temperatures of the water inside the food processor;

a heating stop unit, being configured for controlling the food processor to stop heating when detecting the variable temperatures of the water reach the current boiling point of the water.

Preferably, the first heating execution module further includes:

a power adjustment unit, being configured for when detecting a difference between the variable temperatures of the water and the current boiling point of the water, controlling the food processor to reduce heating power.

When the food processor is powered on, judging whether the food processor generates an initiation instruction for detecting the boiling point based on external actions during a preset time period. If the food processor generates the initiation instruction for detecting the boiling point based on external actions during the preset time period, starting the pre-stored process for detecting the boiling point to obtain a boiling point of the water inside the food processor at a current location, accordingly the food processor is controlled to heat the water based on the boiling point of the water inside the food processor at a current location. Thus only the initiation instruction for detecting the boiling point is detected, the food processor detects the current boiling point, which avoids the food processor to misjudge the boiling point of the water and to continue heating, and hence avoids the mixture of the water and food inside the food processor to overflow.

### BRIEF DESCRIPTION OF THE DRAWINGS

FIG. 1 is a connection diagram of the food processor according to the first embodiment of the present disclosure;

FIG. 2 is a sectional view of the food processor according to the first embodiment of the present disclosure;

FIG. 3 is a flow diagram of the anti-overflow control method for controlling the food processor according to the first embodiment of the present disclosure;

FIG. 4 is a detailed flow diagram showing the step of if the food processor generates the initiation instruction for detecting a boiling point based on external actions during the preset time period, starting a pre-stored process for detecting the boiling point, to obtain the boiling point of water inside the food processor at a current location in the anti-overflow control method for controlling the food processor according to the second embodiment of the present disclosure;

FIG. 5 is a detailed flow diagram showing the step of controlling the food processor to heat water inside the food processor based on the current boiling point of the water in the anti-overflow control method for controlling the food processor according to the third embodiment of the present disclosure;

FIG. 6 is a block diagram of the main control chip in the food processor according to the first embodiment of the present disclosure;

FIG. 7 is a block diagram of the main control chip in the food processor according to an optional embodiment of the present disclosure;

FIG. 8 shows a detailed block diagram of the process starting module in the main control chip in the food processor according to the second embodiment of the present disclosure;

FIG. 9 shows a detailed block diagram of the first heating execution module in the main control chip in the food processor according to the third embodiment of the present disclosure;

Objective achieving, function features, and advantages of the present disclosure are further described with reference to the embodiments and the accompany drawings.

### DETAILED DESCRIPTION OF THE EMBODIMENTS

It should be understood that the specific embodiments described below are only used to explain the present disclosure and are not intended to limit the present disclosure.

It is to be understood that, all the directional instructions in the present disclosure (such as top, down, left, right, front, back) can only be used for explaining relative position relations, moving condition of the elements under a special form (referring to figures), and so on, if the special form changes, the directional instructions changes accordingly. In addition, the descriptions, such as the “first”, the “second” in the present disclosure, can only be used for describing the aim of description, and cannot be understood as indicating or suggesting relative importance or impliedly indicating the number of the indicated technical character.

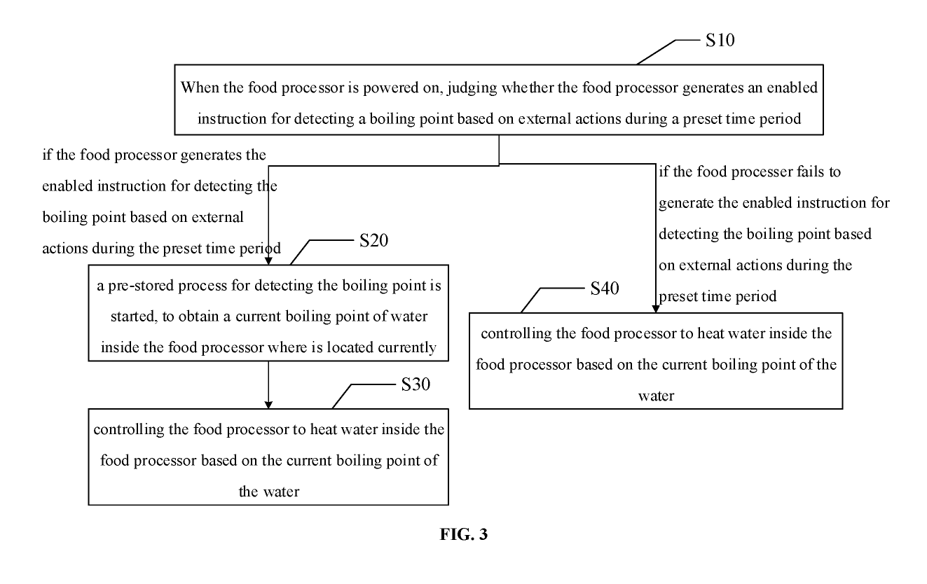

In order to interpret the present disclosure better, an anti-overflow control method for controlling the food processor is disclosed, in the anti-overflow control method for controlling the food processor according to the first embodiment, with reference to FIG. 3, the method comprises:

Step S10, when the food processor is powered on, judging whether the food processor generates an initiation instruction for detecting a boiling point based on external actions during a preset time period;

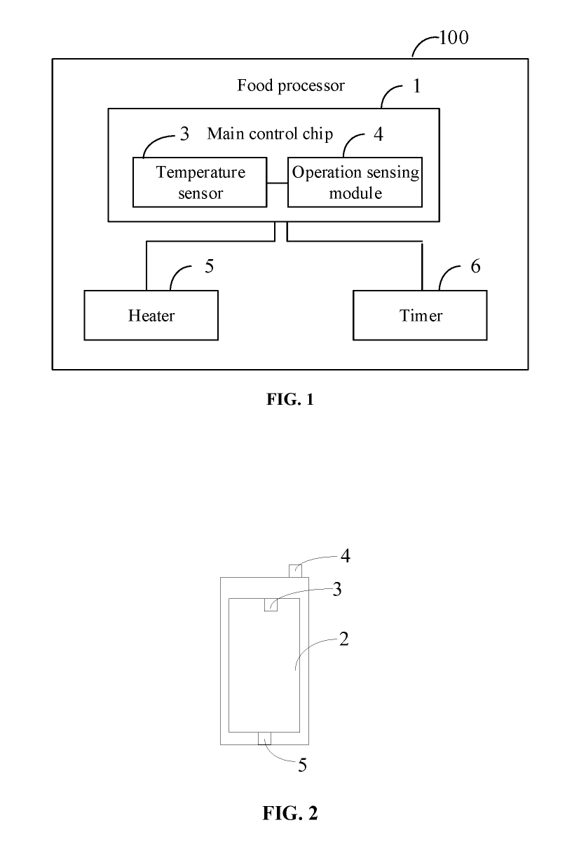

With reference to FIG. 1 and FIG. 2, the food processor 100 may be a soybean milk machine, a wall breaking machine or a blender. The food processor 100 includes a main control chip 1, a heating chamber 2 for receiving the water and food, a temperature sensor 3 and a heater 5. Optionally, the main control chip 1 may include a timer 6 and an operation sensing module 4, a temperature sensor 3 for detecting temperatures inside the heating chamber 2. The temperature sensor 3, the operation sensing module 4, the timer 6 and the heater 5 are electrically connected with the main control chip 1. The heater 5 is configured for heating the heating chamber 2. The main control chip 1 controls the heater 5, the temperature sensor 3, the operation sensing module 4 and the timer 6 in the food processor 100.

Step S20, if the food processor generates the initiation instruction for detecting the boiling point based on external actions during the preset time period, starting a pre-stored process for detecting the boiling point, to obtain the boiling point of water inside the food processor at a current location;

When the main control chip 1 detects the food processor is powered on and the timer 6 starts to count, the main control chip 1 detects whether the operation sensing module 4 in the food processor generates a control instruction based on external actions that may be user′ press operation or touch operation, judging whether the operation sensing module 4 generates the control instruction based on external actions during a preset time period counted by the timer 6. In which, the operation sensing module 4 may be an inductive circuit and physical keys or virtue keys as combined, the virtue keys are visualized and shown on specific areas of the display screen. If the main control chip 1 detects that the operation sensing module 4 has generated the control instruction during a preset time period, then the control instruction is analyzed to judge whether the control instruction matches up with the initiation instruction for detecting the boiling point, if it does, the main control chip 1 starts the preset process of detecting the boiling point to obtain the current boiling point of the water inside the food processor at a current location. The food processor further includes a storage unit, configured for storing the current boiling point of the food processor, which may allow the food processor to heat next time; if it doesn't, that is the control instructions are normal instructions except for the initiation instruction for detecting the boiling point, the main control chip 1 is unresponsive.

Step S30, the food processor is controlled to heat water inside the food processor based on the current boiling point of the water;

After the main control chip 1 detects the boiling point of the water inside the food process at a current location, that is after the main control chip 1 obtains the current boiling point of the water, the heater is controlled to heat the water inside the heating chamber 2 of the food processor, which means, when uses want to detest the boiling point of the food processor at a current location, only need add water into the heating chamber 2 of the food processor.

Step S40, if the food processor fails to generate the initiation instruction for detecting the boiling point based on external actions during the preset time period, the food processor is controlled to heat water inside the food processor based on a pre-stored boiling point in the food processor.

If main control chip 1 does not detect that the food processor has generated the initiation instruction for detecting the boiling point based on external actions during the preset time period, it means users have not functioned the food processor to detest the current boiling point of the water, and hence the main control chip 1 controls the heater to heat the food immersed in the water of the food processor.

In the embodiment, when the food processor is powered on, recognizing the control instruction generated by the food processor based on external actions during the preset time period, if the control instruction has been recognized, the pre-stored process of detecting the boiling point in the food processor to heat the water inside. Therefore only after the initiation instruction for detecting the boiling point has been detected by the food processor, the current boiling point is detected, avoiding the food processor to misjudge the boiling point resulting in continuous heating, avoiding overflow of the mixture of water and food in the food processor accordingly.

Optionally, when the food processor is provided with a specialized button for starting the process of detecting the boiling point, after the specialized button is triggered, controlling the food processor to generate the initiation instruction for detecting a boiling point.

That means, the operation sensing module 4 of the food processor includes a sensing circuit and a specialized button for starting the process of detecting the boiling point, the specialized button may be virtue buttons or physical buttons. When the sensing circuit detects after the specialized button is triggered, the food processor generates the initiation instruction for detecting the boiling point. The specialized button may be located outside the food processor.

When the food processor is only provided with normal functional buttons, after the normal functional buttons as combined are triggered or a single functional button is long-pressed, controlling the food processor to generate the initiation instruction for detecting boiling point.

That means, the operation sensing module 4 of the food processor includes a sensing circuit and a normal functional button, the normal functional button may be a virtue button or a physical button. When the sensing circuit detects the normal functional buttons as combined are triggered or a single functional button is long-pressed, the initiation instruction for detecting boiling point is generated. For instance, the food processor has three normal functional buttons: mode A, mode B and mode C. When the two functional buttons mode A and mode B as combined are triggered simultaneously, the operation sensing module 4 generates the initiation instruction for detecting the boiling point. Meanwhile, the normal functional buttons may be set outside the food processor.

When a wireless connection is used between the food processor and a corresponding mobile terminal, after a trigger instruction sent by the mobile terminal is detected, controlling the food processor to generate the initiation instruction for detecting the boiling point.

That means, the operation sensing module 4 includes a sensing circuit and a wireless module. When the sensing circuit detects, the wireless module connected with external mobile terminals receives trigger instructions sent by the external mobile terminals, the food processor generates the initiation instruction for detecting the boiling point.

In the embodiment, a wide variety of operation sensing modules are disclosed, that is a wide variety of ways to generate the initiation instruction for detecting the boiling point, which riches scenarios of generating the initiation instruction for detecting the boiling point, and provides users diversification of the operations on the pre-stored process of detecting the boiling point in the food processor.

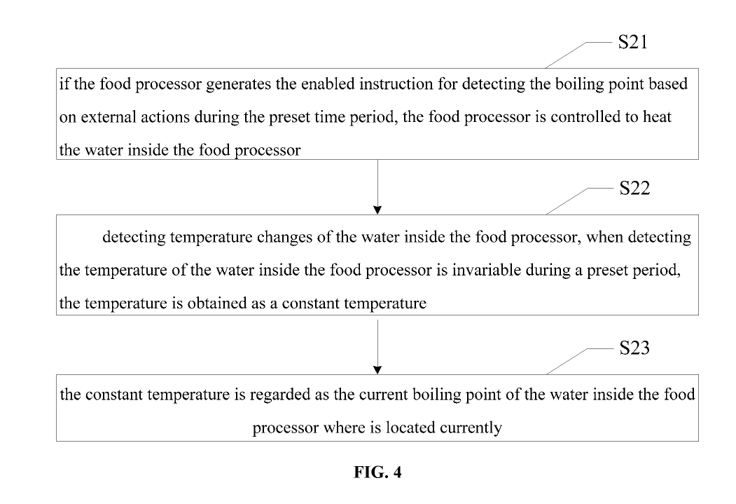

Furthermore, a second embodiment of providing the anti-overflow control method for controlling the food processor is disclosed according the first embodiment, with reference to FIG. 4, in the second embodiment, the step S20 includes:

Step S21, when the food processor generates the initiation instruction for detecting the boiling point based on external actions during the preset time period controlling the food processor to heat the water inside the food processor;

Step S22, detecting temperature changes of the water inside the food processor, when detecting the temperature of the water inside the food processor is invariable during a preset period, the temperature is obtained as a constant temperature;

Step S33, the boiling point of the water inside the food processor at a current location is regarded as the current boiling point of the water.

When the main control chip 1 determines that the operation sensing module 4 generates the initiation instruction for detecting the boiling point based on external actions during the preset time period, the main control chip 1 controls the heater to heat the water inside the heating chamber 2 of the food processor. The main control chip 1 controls the temperature sensor to detect temperature changes of the water inside the heating chamber 2, when the main control chip 1 detects the temperature of the water inside the heating chamber 2 is invariable during the preset period, the temperature is obtained as a constant temperature. The main control chip 1 regards the boiling point of the water inside the food processor at a current location as the current boiling point. Finally, the current boiling point is obtained.

In the embodiment, when it is determined that the food processor generates the initiation instruction for detecting the boiling point based on external actions during the preset time period, the heater is controlled to heat the water inside the heating chamber, detecting the temperature of water inside the heating chamber 2 in real time. When it is determined that the temperature of water inside the heating chamber 2 reaches a preset temperature that is less than the boiling point of water in plateau areas, judging whether the temperature of the water inside the heating chamber 2 is invariable in the preset period, such as 5s, if detecting the temperature of the water inside the heating chamber 2 is invariable in the preset period, it means the water was already boiled, then obtains the invariable temperature as the current boiling point of the water inside the food processor at a current location, which is a relatively simple way to obtain the current boiling point of the water inside the food processor at a current location.

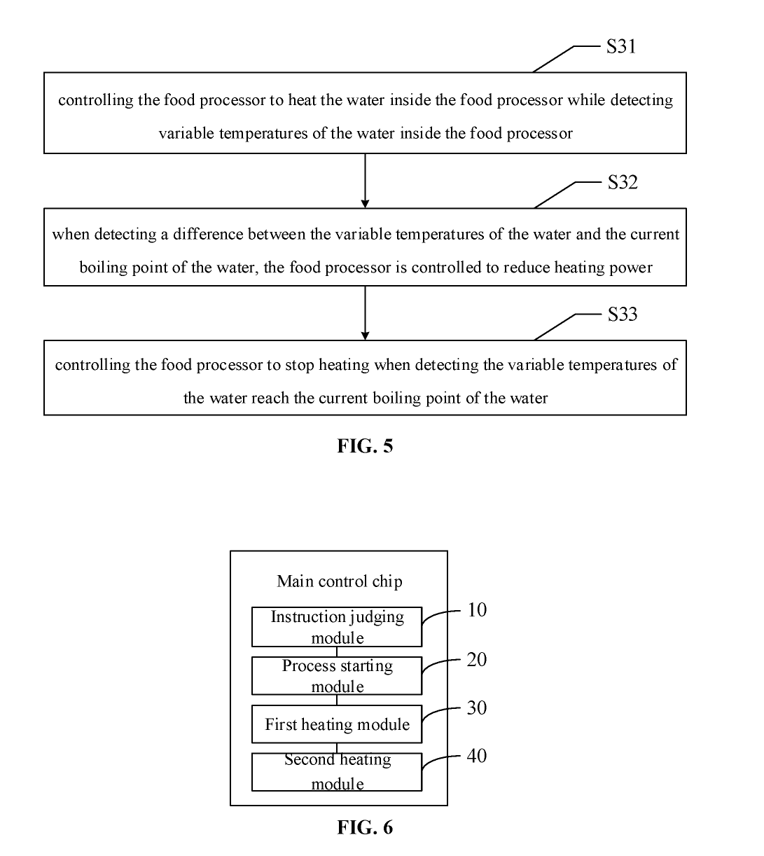

Furthermore, the anti-overflow control method for controlling the food processor is disclosed according to the first embodiment of the present disclosure, with reference to FIG. 5, in the third embodiment, the current boiling point of the water inside the food processor is regarded as the current boiling point.

The step S30 includes:

Step S31, controlling the food processor to heat the water inside the food processor while detecting variable temperatures of the water inside the food processor.

Step S32, when detecting a difference between the variable temperatures of the water and the current boiling point of the water, controlling the food processor to reduce heating power.

Step S33, controlling the food processor to stop heating when detecting the variable temperatures of the water reach the current boiling point of the water.

After the main control chip 1 of the food processor obtains the current boiling point of the water, the heater is controlled to heat the water inside the heating chamber based on the variable temperature of the water detected by the temperature sensor. When the main control chip 1 detects a difference between the variable temperatures of the water and the current boiling point of the water, the heater is controlled to reduce heating power so as to continue heating the heating chamber 2. When the main control chip 1 detects the variable temperatures of the water reach the current boiling point of the water, the heater is controlled to stop heating.

In the embodiment, when the current boiling point of the water is obtained, the food processor is controlled to heat the water inside by using a relatively big power, such as the related power, while detect the temperature changes in the food processor to obtain variable temperatures. Along with the increasing of the variable temperatures, when detecting the variable temperatures reach the current boiling point of the water, controlling the food processor to stop heating, avoiding the water boiling to overflow after a long period of time, accordingly an anti-overflow control method for controlling the food processor during heating, based on the current boiling point is provided.

Moreover, according to the preset boiling point of the water, the principle of controlling the food processor to heat the water and the process of the food process heating the water based on the current boiling point are basically the same.

A food processor is further disclosed, in the first embodiment, the food processor includes a main control chip, with reference to FIG. 6, the main control chip includes:

An instruction judging module 10, is configured for, when the food processor is powered on, judging whether the food processor generates an initiation instruction for detecting the boiling point based on external actions during a preset time period.

With reference to FIG. 1 and FIG. 2, the food processor 100 may be a soybean milk machine, a wall breaking machine or a blender. The food processor 100 includes a main control chip 1, a heating chamber 2 for receiving the water and food, a temperature sensor 3, an operation sensor 3, an operation sensing module 4, a heater 5 and a timer 6. The temperature sensor 3 is configured for detecting the temperature in the heating chamber 2. The temperature sensor 3, the operation sensing module 4, the timer 6 and the heater 5 are all electrically connected with the main control chip 1. The heater 5 is configured for heating the heating chamber 2, the main control chip 1 controls the heater 5, the temperature sensor 3, the operation sensing module 4 and the time 6.

The process starting module 20, is configured for, if the food processor generates the initiation instruction for detecting the boiling point based on external actions during the preset time period, starting the pre-stored process for detecting the boiling point, to obtain the boiling point in the food processor at a current location.

The instruction judging module 10 detects when the food processor is powered on, the timer is started to count, the instruction judging module 10 judges whether the operation sensing module of the food processor generates an initiation instruction for detecting the boiling point based on external actions during a preset time period, in which, the external actions may be the user's pressing operation or touching screen operation; judging whether the operation sensing module generates the initiation instruction for detecting the boiling point based on external actions during the preset time period, in which, the operation sensing module may be the combination of the sensing circuit and the physical buttons or virtue buttons that are visualized and shown on specific areas of the display screen. If the instruction judging module 10 detects the controlling instruction generated by the operation sensing module during a preset time period, the process starting module 20 analyses the controlling instruction and judges whether the controlling instruction matches up with the initiation instruction for detecting the boiling point, if it does, the process starting module 20 starts the preset process of detecting the boiling point to obtain the current boiling point of the water inside the food processor at a current location. The food processor further includes a storage unit, configured for storing the current boiling point of the food processor, which may allow the food processor to heat next time; if it doesn't, that is the control instructions are normal instructions except for the initiation instruction for detecting the boiling point, the process starting module 20 is unresponsive.

A first heating execution module 30, is configured for controlling the food processor to heat water inside the food processor based on the boiling point of the water inside the food processor at a current location.

After the process starting module 20 detects the current boiling point of the water inside the food process at a current location, that is the process starting module 20 obtains the current boiling point of the water, the first heating execution module 30 controls the heater to heat the water inside the food processor, that means, when the users need to detect the current boiling point of the water inside the food processor at a current location, only water needs to be injected into the heating chamber of the food processor.

The second heating execution module 40, is configured for if the food processor fails to generate the initiation instruction for detecting the boiling point based on external actions during the preset time period, controlling the food processor to heat the water inside the food processor based on a pre-stored boiling point in the food processor.

If the instruction judging module 10 fails to detect the operation sensing module of the food processor generates the controlling instruction based on external actions during a preset time period, it means users have not functioned the food processor to detest the current boiling point of the water; when there is no need of detecting the boiling point again, and the second heating execution module 40 controls the heater to heat the food immersed in the water of the food processor according to the pre-stored boiling point of the water.

In the embodiment, when the food processor is powered on, judging whether the food processor generates an initiation instruction for detecting the boiling point based on external actions during a preset time period. If the food processor generates the initiation instruction for detecting the boiling point based on external actions during the preset time period, starting the pre-stored process for detecting the boiling point to obtain a boiling point of the water inside the food processor at a current location, accordingly the food processor is controlled to heat the water based on the boiling point of the water inside the food processor at a current location. Thus only the initiation instruction for detecting the boiling point is detected, the food processor detects the current boiling point, which avoids the food processor to misjudge the boiling point of the water and to continue heating, and hence avoids the mixture of the water and food inside the food processor to overflow.

Optionally, with reference to FIG. 7, the food processor thereof further includes an operation sensing module 4.

When the food processor is provided with a specialized button for starting the process of detecting the boiling point, after the specialized button is triggered, the operation sensing module 4 is functioned to generate the initiation instruction for detecting the boiling point.

That means, the operation sensing module of the food processor includes a sensing circuit and a specialized button for starting the process of detecting the boiling point. The specialized button is a virtue button or physical button, when the sensing circuit detects after the specialized button is triggered, the operation sensing module 4 generates the initiation instruction for detecting the boiling point.

When the food processor is only provided with normal functional buttons, after the normal functional buttons as combined are triggered or a single functional button is long-pressed, the operation sensing module 4 is functioned to generate the initiation instruction for detecting boiling point.

That means, the operation sensing module of the food processor includes a sensing circuit and normal functional buttons. The normal functional buttons are virtue buttons or physical buttons, when the sensing circuit detects the preset normal functional buttons as combined are triggered or the single functional button is long-pressed, the initiation instruction for detecting the boiling point is generated. For instance, the food processor has three normal functional buttons: mode A, mode B and mode C. When the two functional buttons mode A and mode B as combined are triggered simultaneously, the operation sensing module 4 is functioned to generate the initiation instruction for detecting the boiling point.

When a wireless connection is used between the food processor and a corresponding mobile terminal, after a trigger instruction sent by the mobile terminal is detected, the operation sensing module 4 is functioned to generate the initiation instruction for detecting boiling point.

That is, the operation sensing module 4 includes a sensing circuit and a wireless module, when the sensing circuit detects the wireless module set to connect with external mobile terminals receives the trigger instruction for detecting the boiling point sent by the mobile terminals, the operation sensing module 4 generates the initiation instruction for detecting the boiling point.

In the embodiment, a wide variety of operation sensing modules are disclosed, that is a wide variety of ways to generate the initiation instruction for detecting the boiling point, which riches scenarios of generating the initiation instruction for detecting the boiling point, and provides users diversification of the operations on the pre-stored process of detecting the boiling point in the food processor.

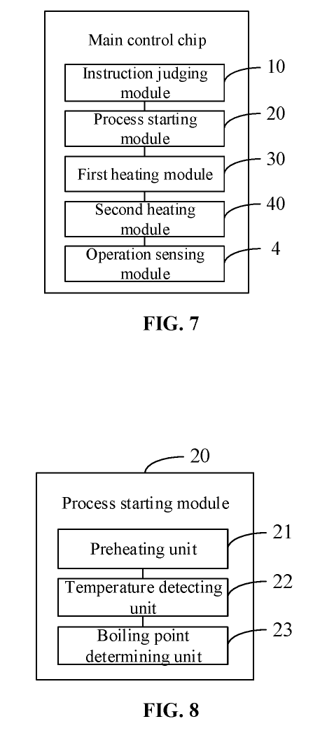

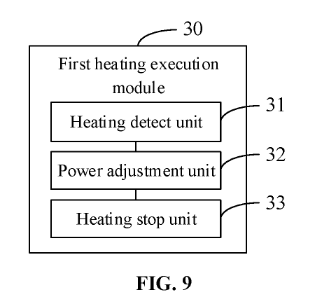

Furthermore, the food processor thereof of the second embodiment is disclosed based on the first embodiment, with reference to FIG. 8, the process starting module 20 includes:

a preheating unit 21, being configured for, when the food processor generates the initiation instruction for detecting the boiling point based on external actions during the preset time period controlling the food processor to heat the water inside the food processor;

a temperature detecting unit 22, being configured for, detecting temperature changes of the water inside the food processor, when detecting the temperature of the water inside the food processor is invariable during the preset period, the temperature is obtained as a constant temperature;

a boiling point determining unit 23, being configured for regarding the constant temperature as the boiling point of the water inside the food processor at a current location.

When the instruction judging module 10 judges whether the operation sensing module of the food processor generates an initiation instruction for detecting a boiling point based on external actions during a preset time period, a preheating unit 21 controls the heater to heat the water inside the heating chamber of the food processor, the temperature detecting unit 22 controls the temperature sensor to detect temperature changes of the water inside the food processor, when the temperature detecting unit 22 detects the temperature of the water inside the heating chamber of the food processor is invariable, the invariable temperature is obtained as the constant temperature. The boiling point determining unit 23 regards the constant temperature as the boiling point of the water inside the food processor at a current location.

In the embodiment, when judging the controlling instruction is the preset initiation instruction for detecting the boiling point, the heater is controlled to heat the water inside the heating chamber, while detecting the temperatures of the water inside the heating chamber. When detecting the temperature of the water reaches a preset temperature that is less than the boiling point of water in plateau areas, judging whether the temperature of the water inside the heating chamber 2 is invariable in the preset period, such as 5s, if detecting the temperature of the water inside the heating chamber 2 is invariable in the preset period, it means the water was already boiled, then the invariable temperature is obtained as the current boiling point of the water inside the food processor at a current location, which is a relatively simple way to obtain the current boiling point of the water inside the food processor at a current location.

Furthermore, the food processor thereof of the third embodiment is further disclosed based on the first embodiment, with reference to FIG. 9, the boiling point of the water inside the food processor is regarded as the current boiling point.

A first heating execution module 30 includes:

a heating detect unit 31, being configured for controlling the food processor to heat the water inside the food processor while detecting variable temperatures of the water inside the food processor;

a power adjustment unit 32, being configured for when detecting a difference between the variable temperatures of the water and the current boiling point of the water, controlling the food processor to reduce heating power;

a heating stop unit 33, being configured for controlling the food processor to stop heating when detecting the variable temperatures of the water reach the current boiling point of the water.

After the process starting module 20 of the food processor obtains the current boiling point of the water, the heating detect unit 31 controls the heater to heat the water inside the food processor while detecting variable temperatures of the water inside the food processor. When the power adjustment unit 32 detects the difference between the variable temperatures of the water and the current boiling point of the water, the heating power is reduced while continuing heating the heating chamber. When the heating stop unit 33 detects the variable temperatures of the water reach the current boiling point of the water, the heater is controlled to stop heating.

In the embodiment, when the current boiling point is obtained, the food processor is controlled to heat the water inside by using a relatively big power, while detecting the temperature changes of the water as the variable temperatures. Along with the increasing of the variable temperatures, until when detecting a difference between the variable temperatures of the water and the current boiling point of the water, controlling the food processor to reduce heating power, which avoids water to heat up rapidly inside the food processor because of the excessive heating power, and hence avoids the overflow of the mixture of water and food because of violent boiling. Meanwhile with the increasing of the variable temperatures, until when detecting variable temperatures reach the current boiling point, controlling the food processor to stop heating so as to avoid the overflow because of long time boiling. In general, an anti-overflow control method is disclosed based on the current boiling point of the water.

Moreover, the principle of heating the water inside the food process is basically in line with the process of the food processor heating water based on the current boiling point, according to the pre-stored boiling point of the water.

In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

The present disclosure is not limited to the invention; the related technical fields are included within the scope of the patent protection of the present disclosure. The foregoing descriptions are merely embodiments of the present disclosure, and are not intended to limit the scope of the present disclosure. An equivalent structural or equivalent process alternation made by using the content of the specification and drawings of the present disclosure, or an application of the content of the specification and drawings directly or indirectly to another related technical field, shall fall within the protection scope of the present disclosure.

What is claimed is:

1. An anti-overflow control method for controlling a food processor comprising:
when the food processor is powered on, judging whether the food processor generates an initiation instruction for detecting a boiling point based on external actions during a preset time period;
if the food processor generates the initiation instruction for detecting the boiling point based on external actions during the preset time period, starting a pre-stored process for detecting the boiling point, to obtain a current boiling point of water inside the food processor at a current location;
controlling the food processor to heat water inside the food processor based on the current boiling point of the water; and
if the food processor fails to generate the initiation instruction for detecting the boiling point based on external actions during the preset time period, controlling the food processor to heat water inside the food processor based on a pre-stored boiling point in the food processor.

2. The anti-overflow control method for controlling the food processor of claim 1, further comprising:
when the food processor is provided with a specialized button for starting a process of detecting the boiling point, after the specialized button is triggered, controlling the food processor to generate the initiation instruction for detecting the boiling point;
when the food processor is only provided with normal functional buttons, after the normal functional buttons as combined are triggered or a single functional button is long-pressed, controlling the food processor to generate the initiation instruction for detecting the boiling point; and
when a wireless connection is used between the food processor and a corresponding mobile terminal, after a trigger instruction sent by the mobile terminal is detected, controlling the food processor to generate the initiation instruction for detecting boiling point.

3. The anti-overflow control method for controlling the food processor of claim 1, wherein, if the food processor generates the initiation instruction for detecting the boiling point based on external actions during the preset time period, starting the pre-stored process for detecting the boiling point to obtain the boiling point of the water inside the food processor at a current location, comprises:
if the food processor generates the initiation instruction for detecting the boiling point based on external actions during the preset time period, controlling the food processor to heat the water inside the food processor; and
detecting temperature changes of the water inside the food processor, wherein, when detecting the temperature of the water inside the food processor is invariable during a preset period, the temperature is obtained as a constant temperature; the constant temperature is regarded as the current boiling point of the water inside the food processor at the current location.

4. The anti-overflow control method for controlling the food processor of claim 1, wherein, the step of controlling the food processor to heat water inside the food processor based on the current boiling point, comprises:
controlling the food processor to heat the water inside the food processor while detecting variable temperatures of the water inside the food processor; and
when detecting the variable temperatures of the water reach the current boiling point of the water, controlling the food processor to stop heating.

5. The anti-overflow control method for controlling the food processor of claim 2, wherein, the step of controlling the food processor to heat water inside the food processor based on the current boiling point, comprises:
controlling the food processor to heat the water inside the food processor while detecting variable temperatures of the water inside the food processor; and
when detecting the variable temperatures of the water reach the current boiling point of the water, controlling the food processor to stop heating.

6. The anti-overflow control method for controlling the food processor of claim 3, wherein, the step of controlling the food processor to heat water inside the food processor based on the current boiling point, comprises:
controlling the food processor to heat the water inside the food processor while detecting variable temperatures of the water inside the food processor; and
when detecting the variable temperatures of the water reach the current boiling point of the water, controlling the food processor to stop heating.

7. The anti-overflow control method for controlling the food processor of claim 5, wherein, before the step of when detecting the variable temperatures of the water reach the current boiling point of the water, controlling the food processor to stop heating further comprises:
when detecting a difference between the variable temperatures of the water and the current boiling point of the water, controlling the food processor to reduce heating power.

8. The anti-overflow control method for controlling the food processor of claim 6, wherein, before the step of when detecting the variable temperatures of the water reach the current boiling point of the water, controlling the food processor to stop heating further comprises:
when detecting a difference between the variable temperatures of the water and the current boiling point of the water, controlling the food processor to reduce heating power.

9. The anti-overflow control method for controlling the food processor of claim 7, wherein, before the step of when detecting the variable temperatures of the water reach the current boiling point of the water, controlling the food processor to stop heating further comprises:
when detecting a difference between the variable temperatures of the water and the current boiling point of the water, controlling the food processor to reduce heating power.

10. A food processor comprising a main control chip, wherein the main control chip comprises:
an instruction judging module, being configured for, when the food processor is powered on, judging whether the food processor generates an initiation instruction for detecting a boiling point based on external actions during a preset time period;
a process starting module, being configured for, if the food processor generates the initiation instruction for detecting the boiling point based on external actions during the preset time period, starting a pre-stored process for detecting the boiling point, to obtain a boiling point in the food processor at a current location;
a first heating execution module, being configured for controlling the food processor to heat water inside the food processor based on the boiling point of the water inside the food processor at a current location; and
a second heating execution module, being configured for, if the food processor fails to generate the initiation instruction for detecting the boiling point based on external actions during the preset time period, controlling the food processor to heat the water inside the food processor based on a pre-stored boiling point in the food processor.

11. The food processor of claim 10, wherein, the main control chip comprises an operation sensing module;
when the food processor is provided with a specialized button for starting a process of detecting the boiling point, after the specialized button is triggered, controlling the food processor to generate the initiation instruction for detecting a boiling point;
when the food processor is only provided with normal functional buttons, after the normal functional buttons as combined are triggered or a single functional button is long-pressed, controlling the food processor to generate the initiation instruction for detecting boiling point;
when a wireless connection is used between the food processor and a corresponding mobile terminal, after a trigger instruction sent by the mobile terminal is detected, controlling the food processor to generate the initiation instruction for detecting boiling point.

12. The food processor of claim 10, wherein, the process starting module comprises:
a preheating unit, being configured for, when the food processor generates the initiation instruction for detecting the boiling point based on external actions during the preset time period, controlling the food processor to heat the water inside the food processor; and
a temperature detecting unit, being configured for, detecting temperature changes of the water inside the food processor, wherein, when detecting the temperature of the water inside the food processor is invariable during the preset period, the temperature is obtained as a constant temperature; a boiling point determining unit, being configured for regarding the constant temperature as the boiling point of the water inside the food processor at a current location.

13. The food processor of claim 10, wherein, the first heating execution module comprises:
a heating detect unit, being configured for controlling the food processor to heat the water inside the food processor while detecting variable temperatures of the water inside the food processor;
a heating stop unit, being configured for controlling the food processor to stop heating when detecting the variable temperatures of the water reach the current boiling point of the water.

14. The food processor of claim 10, wherein the first heating execution module further comprises:
a power adjustment unit, being configured for when detecting a difference between the variable temperatures of the water and the current boiling point of the water, controlling the food processor to reduce heating power.

15. The food processor of claim 10, wherein the food processor is one selected from the group consisting of a soybean milk machine, a wall breaking machine and a blender.
